(19) United States
(12) Patent Application Publication
(10) Pub. No.: US 2018/0245540 A1
(43) Pub. Date: Aug. 30, 2018

(54) CONVERGENT-DIVERGENT NOZZLE FOR A TURBOFAN ENGINE OF A SUPERSONIC AIRCRAFT AND METHOD FOR REDUCING THE BASE DRAG BEHIND SUCH NOZZLE

(71) Applicant: Rolls-Royce Deutschland Ltd & Co KG, Blankenfelde-Mahlow (DE)

(72) Inventor: Predrag TODOROVIC, Berlin (DE)

(21) Appl. No.: 15/901,389

(22) Filed: Feb. 21, 2018

(30) Foreign Application Priority Data
Feb. 27, 2017 (DE) 10 2017 104 043.9

(51) Int. Cl. F02K 1/12

(52) U.S. Cl. CPC F02K 1/12; F05D 2250/324; F05D 2250/323

(57) ABSTRACT

A convergent-divergent nozzle for a turbofan engine of a supersonic aircraft, wherein the nozzle has an inner wall that delimits a flow channel through the nozzle radially outside, wherein the flow channel has a nozzle throat surface and a nozzle exit surface. The inner wall includes a first group of adjustable segments forming an upstream convergent area of the nozzle, and second group of adjustable segments forming a downstream constant/divergent area of the nozzle. It is provided that the segments of the first group or the segments of the second group are curved towards the flow channel in a convex manner at least in an area that adjoins the other group, forming the nozzle throat surface in the area of the convex curvature and adjoining the segments of the respectively other group at an axial distance to the axial position of the nozzle throat surface.

### REFERENCE TO RELATED APPLICATION

This application claims priority to German Patent Application No. 10 2017 104 043.9 filed on Feb. 27, 2017, the entirety of which is incorporated by reference herein.

### BACKGROUND

The invention relates to a convergent-divergent nozzle for a turbofan engine of a supersonic aircraft and a method for reducing the base drag behind such nozzle.

In general, it is desirable if a plurality of combinations can be realized in a convergent-divergent nozzle with regard to the nozzle throat surface (usually referred to as A8) and the nozzle exit surface (usually referred to as A9) so as to be able to set these parameters in a suitable manner independently of the operating mode of the turbofan engine. For this purpose, it is known to embody a nozzle with a variable contour, for example as an iris/petal nozzle with a plurality of individually adjustable segments. Thus, it is known to provide a group of adjustable convergent segments and a group of adjustable divergent segments in a nozzle, which are respectively arranged in a circular manner. In order for the individual segments to be adjustable, they are connected to actuators. Such a nozzle is for example known from U.S. Pat. No. 9,464,594 B2, as well as from the engines of the fighter jets McDonnell Douglas F-15, Suchoi Su-27, and Suchoi Su-34.

A disadvantage of such nozzles is that strong shock waves may occur at the nozzle throat surface due to the transitions from a subsonic flow to a supersonic flow taking place in that position, which contributes to engine noise.

There is a need to provide a convergent-divergent nozzle of a turbofan engine that is suitable for supersonic operation and that produces less noise. There is a further need for a method for reducing the base drag behind such nozzle.

### SUMMARY

According to an aspect of the invention a convergent-divergent nozzle is provided that comprises an inner wall that comprises a first group of adjustable segments as well as a second group of adjustable segments. The first group of adjustable segments forms an upstream convergent area of the nozzle. The second group of adjustable segments forms a downstream constant/divergent area of the nozzle. It is provided that the segments of the first group or the segments of the second group are curved in a convex manner towards the flow channel at least in an area that adjoins the other group, thus forming the nozzle throat surface in the area of the convex curvature and adjoining the segments of the respectively other group at an axial distance to the axial position of the nozzle throat surface.

Aspect of the invention are thus based on the idea of providing the inner wall of the nozzle, which represents the radially outer boundary of the flow channel inside the nozzle, with a convex curvature in the area of the nozzle throat surface. The transition between the convergent area of the nozzle and the divergent area of the nozzle is thus not realized in an abrupt manner and with a bent being formed, but rather gradually and with a smooth inner wall being formed in the transition between the convergent area and the divergent area. Due to the convex curvature of the inner wall in the area of the nozzle throat surface and the resulting smooth transition between the convergent area of the nozzle and the divergent area of the nozzle, the generation of shock waves in the nozzle is reduced, and thus a noise reduction is obtained. In particular, the shock waves that are generated are weaker, thus generating less noise and consequently less loss as compared to strong shock waves.

At that, aspects of the invention comprises two basic embodiments. According to the one embodiment, the segments of the first group forming the upstream convergent area of the nozzle are curved in a convex manner towards the flow channel. The segments of the first group thus form the nozzle throat surface. Downstream of the nozzle throat surface, they abut the segments of the second group, or are connected to them in that position.

According to the other embodiment, the segments of the second group forming the downstream constant/divergent area of the nozzle are curved in a convex manner towards the flow channel. In this embodiment, the segments of the second group thus form the nozzle throat surface. They abut the segments of the first group upstream of the nozzle throat surface, or are connected to them in that position.

What is thus provided in the two mentioned basic embodiments is a formation of the curved or arched area by the first group of adjustable segments or by the second group of adjustable segments.

It is to be understood that, within the meaning of the present invention, the wording according to which the segments of the first group and the segments of the second group abut each other comprises a plurality of transitions between the ends of the segments of the respective groups. Here, it generally applies that, downstream of the circumferential line at which the segments of both groups abut each other, the flow channel is no longer formed by the first group of segments, but instead by the second group of segments. Here, the contact or transition between the segments of both groups can be realized in many different ways. As will be explained in the following, the contact or transition can be realized by means of overlapping, for example in connection with a slide mechanism. Alternatively, the segments can be connected to each other via articulated joints, such as for example hinges, at the position where they adjoin each other or abut each other. In principle, it is also possible that an abutment of the segments of the respective groups merely means that the facing ends of the segments are positioned so as to be neighboring each other, without necessarily a mechanical connection or overlapping being present.

The rear constant/divergent area of the nozzle either has a substantially constant cross-sectional surface or a cross-sectional surface that is increasing in flow direction independently of the operating state of the nozzle.

According to an embodiment of the invention, it is provided that the segments of both groups abut each other in such a manner that respectively two segments overlap each other. Here, it is provided that respectively a linearly shaped segment of the one group overlaps a convexly curved segment of the other group. Here, it is to be understood that a linearly shaped has to be embodied in a linear manner only in its axial or longitudinal direction. As for directions that are perpendicular to the axial direction, it can by all means be formed in a curved manner.

It can be provided that two segments of both groups respectively abut each other and are aligned with respect to one another in such a manner that the linearly shaped segment forms the tangential extension of the convex curved segment. With respect to the flow channel, the linear segment thus extends along the tangent that has the curved segment at the point or the circumferential line at which the linear segment abuts the curved segment. Following its curvature, the curved segment plunges to behind the linear segment behind the circumferential line at which the two segments abut each other, thus no longer delimiting the flow channel from this circumferential line on.

Further, it is provided in one embodiment of the invention that the linearly shaped segment abuts radially inside at the convexly curved segment of the other group and/or forms a beveled edge at its end that is facing towards the convex curved segment. Through the beveled edge, a smooth boundary of the flow channel is provided at the transition between segments that are arranged behind each other in the axial direction or the upstream convergent area and the downstream constant/divergent area of the nozzle. As a result of the mentioned order of the overlap, the linearly formed segment is located in front of the convex curved segment (that is, radially inside from it) with respect to the flow channel. As a result, a consistently smooth transition between the segments is ensured even if the degree of overlap between the segments changes as the nozzle throat surface is altered.

In a further embodiment of the invention, it is provided that the convex curved segments of the one group are curved in a convex manner only in the area that adjoins the segments of the other group, and otherwise extend in the longitudinal direction in a substantially linear manner. The curvature of the segments thus extends up to the segment end or the segment beginning of the segment that is facing the segment beginning or the segment end of the adjoining segment of the other group. In other words, the curved segments are curved in a convex manner where they from the nozzle throat surface, and further up to their ends that adjoin the segments of the respectively other group, but are otherwise formed in a linear manner. However, in principle it is also possible that the curved segments are formed in a curved manner over their entire length.

In other words, it is provided in one embodiment that the segments of the first group forming the upstream converging area of the nozzle converge in a conical manner in front of the nozzle throat surface, and are curved towards the flow channel in a convex manner in the area of the nozzle throat surface, and further up to its downstream end. In another embodiment, it is provided that the segments of the second group of adjustable segments forming the downstream constant/divergent area of the nozzle are curved towards the flow channel in a convex manner in the area of the nozzle throat surface and further up to its upstream end, and diverge in a conical manner towards their downstream end.

In a further embodiment of the invention, it is provided that adjoining segments of both groups are connected to each other by a slide mechanism, with the adjoining segments of both groups overlapping. The slide mechanism is formed for the purpose of providing that the adjoining segments change their degree of overlap as the nozzle throat surface is being adjusted. As a result, a smooth transition between the adjoining segments of both groups is facilitated with any set size of the nozzle throat surface.

By realizing a transition and contact between segments of the first group and segments of the second group by means of a slide mechanism, it is possible to also realize curvatures at the segments of the first group or the second group in which the pivot axis of the convex curved area is located outside of the nozzle.

In principle, the slide mechanism can be realized in various manner, for example with a rail being provided at the one segment and a guide element displaceable thereon and connected to the other segment. In one respective embodiment, it is provided that the slide mechanism has a curved longitudinal guide that is formed on the side of the segments that is facing away from the flow channel.

In one exemplary embodiment, a curved longitudinal guide is provided for this purpose, namely in such a manner that the longitudinal guide has a curved rail that is curved corresponding to the convex curvature of the convexly curved segment and that is connected to the non-convexly curved segment. Further, the longitudinal guide comprises an elongated receiving profile that is curved corresponding to the convex curvature of the convexly curved segment and formed at the convexly curved segment. At that, the curved rail is longitudinally displaceable inside the curved receiving profile.

In further alternative embodiments, the slide mechanism is constructed corresponding to a mechanism as it is used for driving rear flaps or front flaps at the wings, typically by using a linearly movable linkage. The slide mechanism can also comprise a roller mechanism.

The nozzle can be embodied as a three-dimensional nozzle or as a two-dimensional nozzle. Correspondingly, it either has a substantially circular cross section or a substantially rectangular cross section (with roundings at the edges).

In the case of a three-dimensional nozzle, the segments of both groups are respectively arranged in a manner distributed in the circumferential direction about the longitudinal axis of the nozzle. The segments are in particular lamellas or flaps of an iris/petal nozzle. Here, the individual segments of both groups can respectively be adjusted by means of dedicated actuators. Here, the adjustment of the segments of a group can be performed individually for each segment, or alternatively for example via an adjusting ring that is connected to the segments of the group, with the segments being adjusted as the adjusting ring is being adjusted.

In the case of a two-dimensional nozzle, it is provided in one embodiment of the invention that the nozzle has two facing stationary walls (which can be aligned in parallel) as well as two facing adjustable walls in the upstream convergent area, and also has two facing stationary walls (which can be aligned in parallel) as well as two facing adjustable walls in the downstream divergent area. Here, it is provided that the adjustable walls of the convergent area or the adjustable walls of the divergent area are curved in a convex manner towards the flow channel, forming the nozzle throat surface in the area of the convex curvature and abutting the adjustable walls of the respectively other area at an axial distance to the axial position of the nozzle throat surface. The two stationary walls can for example be two side walls, and the two adjustable walls can be an upper wall and a lower wall. Alternatively, the side walls are adjustable.

In one respective embodiment, it is provided that, as further adjustable segments, the nozzle has segments rounded in the circumferential direction located in the corner areas between the stationary walls and the adjustable walls in the upstream convergent area as well as in the downstream divergent area, wherein it also applies to the rounded segments that the rounded segments of the convergent area or the rounded segments of the divergent area are curved in a convex manner towards the flow channel, contributing to the formation of the nozzle throat surface (A8) in the area of the convex curvature and abutting a rounded segment of the respectively other area at an axial distance to the axial position of the nozzle throat surface.

In a further embodiment of the invention, it is provided that the segments of the first group and the segments of the second group abut each other in such a manner that gas flows between them from the flow channel into a hollow space between the inner wall and an outer wall of the nozzle, wherein this hollow space is formed in such a manner that the inflowing gas is discharged from the hollow space or the nozzle in the area of a trailing edge gap between the inner wall and the outer wall. Alternatively or additionally, it can be provided that, at the upstream end of the upstream convergent area of the nozzle, passages are formed in the inner wall of the nozzle in such a manner that gas flows into a hollow space between the inner wall and an outer wall of the nozzle, wherein the hollow space is formed in such a manner that the inflowing gas is discharged from the hollow space or the nozzle in the area of a trailing edge gap between the inner wall and the outer wall. In both cases, the air at the circumference of the nozzle exit is supplied with additional energy by the discharged gas, and a reduction of the base drag is achieved.

According to a further aspect of the invention, the invention relates to a convergent-divergent nozzle for a turbofan engine of a supersonic aircraft, comprising:
an inner wall that delimits a flow channel through the nozzle radially outside, wherein the flow channel forms a nozzle throat surface and a nozzle exit surface,
wherein the inner wall comprises: a first group of adjustable segments forming an upstream convergent area of the nozzle, and a second group of adjustable segments forming a downstream constant/divergent area of the nozzle,
wherein the segments of the first group or the segments of the second group are curved towards the flow channel in a convex manner at least in an area that adjoins the other group, forming the nozzle throat surface in the area of the convex curvature and abutting segments of the respectively other group at an axial distance to the axial position of the nozzle throat surface,
the segments of both groups abut each other in such a manner that respectively two segments overlap each other, wherein respectively one linearly shaped segment of the one group overlaps a convexly curved segment of the other group, and wherein
the convexly curved segments of the one group are curved in a convex manner only in an area that adjoins the segments of the other group, and otherwise extend in a substantially linear manner in the longitudinal direction.

According to a further aspect of the present invention, a method for reducing the base drag behind a nozzle is provided, wherein the method comprises:
conducting gas of the flow channel from the upstream end of the upstream area of the nozzle and/or between the upstream and the downstream area of the nozzle into a hollow space between the inner wall and an outer wall of the nozzle;
conducting the inflowing gas inside the hollow space between the inner wall and the outer wall in such a manner that it is discharged from the nozzle in the area of a trailing edge gap between the inner wall and the outer wall.

The gas that is discharged from the nozzle in the area of a trailing edge gap between the inner wall and the outer wall supplies additional energy to the flow at the circumference of the nozzle exit, and thus reduces the base drag of the nozzle. As a result, the efficiency of the nozzle is increased. The method can be realized in a nozzle according to claim 1, but in principle also with any other type of nozzle, in particular convergent-divergent nozzles, for example also a nozzle in iris/petal design.

In one respective embodiment, it is provided that gas of the flow channel flows into the hollow space between the segments of the first group and the segments of the second group of the nozzle. This is in particular provided for the case that the convex curvature is formed in the upstream convergent area of the nozzle. In this case, gas of the flow channel flows into the hollow space in the position where the segments of the downstream constant/divergent area of the nozzle overlap with the curved segments of the upstream convergent area of the nozzle. For this purpose, a gap between the respective segments is for example provided in the overlap area, ensuring that the gas can flow into the hollow space.

In contrast to that, in the alternative case that the convex curvature is formed in the downstream constant/divergent area of the nozzle, the gap between the segments of the two areas of the nozzle in the overlap area is minimized to prevent gas from flowing from the hollow space into the flow channel. For, in that case, the gap is located in the conically converging area of the nozzle.

In a further embodiment of the method, it is provided that gas flows at the upstream end of the upstream area from the flow channel into the hollow space, for example at the transition between the upstream end of the segments and a solid structure at which they are hinged. Here, it can be provided that otherwise customary used seals can be foregone, which additionally leads to a reduction in cost and effort.

In a further embodiment of the method according to the invention, it is provided that the trailing edge gap has a flow cross section that changes depending on the set nozzle exit surface and that is largest when the downstream constant/divergent area of the nozzle is formed in a constant (e.g. cylindrical) manner, i.e. with a constant cross section. This corresponds to the situation during take off thrust MTO (MTO=maximum takeoff thrust).

It is to be understood that the present invention is described with respect to a cylindrical coordinate system, having the coordinates x, r and φ. Here, x indicates the axial direction, r indicates the radial direction, and φ indicates the angle in the circumferential direction, with the axial direction being identical to the machine axis of the turbofan engine. Beginning at the x-axis, the radial direction points radially outward. Terms such as “in front”, “behind”, “frontal” and “rear” always refer to the axial direction or the flow direction inside the engine. Thus, the term “in front” means “upstream”, and the term “behind” means “downstream”. Terms such as “outer” or “inner” always refer to the radial direction.

In further aspects, the invention relates to a turbofan engine with a nozzle according to the invention and a civilian or military supersonic aircraft with such a turbofan engine.

### BRIEF DESCRIPTION OF THE DRAWINGS

The invention will be explained in more detail on the basis of exemplary embodiments with reference to the accompanying drawings in which:

FIG. 1 shows an exemplary embodiment of the rear part of a turbofan engine that is suitable for the use in a supersonic aircraft, wherein the shown part has a nozzle with convexly curved segments in an upstream convergent area of the nozzle;

FIG. 2 shows the nozzle of FIG. 1, wherein the convexly curved segments of the nozzle are in a first position;

FIG. 3 shows the nozzle of FIG. 1, wherein the convexly curved segments of the nozzle are in a second position;

FIG. 4 shows the nozzle of FIG. 1, wherein the convexly curved segments of the nozzle are in a third position,

FIG. 5 shows the nozzle of FIG. 1, wherein the tree positions of the convexly curved segments according to FIGS. 2 to 4 are simultaneously shown;

FIG. 6 shows a lateral perspective rendering of a slide mechanism that serves for connecting segments of the convergent area and segments of the cylindrical/divergent area of a nozzle according to FIGS. 1 to 5, wherein the slide mechanism is formed at the side of the segment that is facing away from the flow channel;

FIG. 7 shows the slide mechanism of FIG. 6 in a perspective rendering obliquely from behind;

FIG. 8 shows a lateral perspective rendering of the slide mechanism of FIGS. 6 and 7 in an adjusting position that differs with respect to FIGS. 6 and 7;

FIG. 9 shows the slide mechanism of FIG. 8 in a perspective rendering obliquely from behind;

FIG. 10 shows, in a schematic manner, the cross sections of a three-dimensional and a two-dimensional nozzle;

FIG. 11 shows, in longitudinal section, an exemplary embodiment of a two-dimensional nozzle that has convexly curved segments in an upstream convergent area of the nozzle;

FIG. 12 shows the nozzle of FIG. 11 in a view obliquely from the front;

FIG. 13 shows the nozzle of FIG. 11 in a view obliquely from behind;

FIG. 14 shows a longitudinal section of the nozzle of FIGS. 11 to 13 in an adjusting position of the convexly curved segments that differs with respect to 11 to 13;

FIG. 15 shows the nozzle of FIG. 14 in a view obliquely from the front; and

FIG. 16 shows the nozzle of FIG. 14 in a view obliquely from behind.

### DETAILED DESCRIPTION

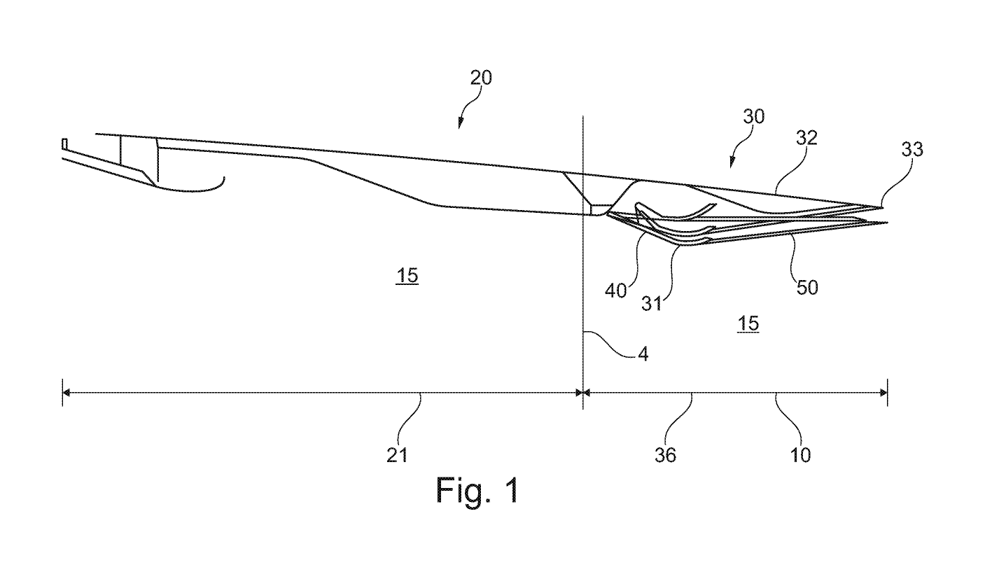

FIG. 1 shows the rear part of a turbofan engine which is provided and suitable for being used in a civilian or military supersonic aircraft, and is correspondingly designed for operating conditions in the subsonic range, in the transsonic range, and in the supersonic range.

In the front part, which is not shown, the turbofan engine comprises an engine intake, a fan that can be embodied with multiple stages, a primary flow channel leading through a core engine, and a secondary flow channel or bypass channel that is guided past the core engine.

The engine intake forms a supersonic air inlet and is correspondingly provided and suitable for slowing down the inflowing air to velocities of below Ma 1.0 (Ma=Mach number). The engine intake can be formed in a beveled manner so as to achieve a favorable compression shock configuration during supersonic flight.

The core engine has a compressor, a combustion chamber, and a turbine. For example, the compressor comprises a high-pressure compressor and a low-pressure compressor, wherein a low-pressure compressor can be formed by the areas of the fan that are located close to the hub. The turbine that is arranged behind the combustion chamber comprises a high-pressure turbine and a low-pressure turbine. The high-pressure turbine drives a high-pressure shaft that connects the high-pressure turbine to the high-pressure compressor. The low-pressure turbine drives a low-pressure shaft that connects the low-pressure turbine to the fan. According to an alternative embodiment, the turbofan engine can additionally comprise a medium-pressure compressor, a medium-pressure turbine, and a medium-pressure shaft.

The turbofan engine further comprises a mixer that mixes air of the secondary flow channel and of the primary flow channel behind the core engine.

The turbofan engine is arranged inside an engine nacelle which is connected to the fuselage, for example via a pylon.

Referring to FIG. 1, the turbofan engine comprises a machine axis 10 or engine center line. The machine axis defines an axial direction of the turbofan engine. A radial direction of the turbofan engine extends perpendicular to the axial direction. Behind the mixer, the engine forms a flow channel 15 that extends through the convergent-divergent nozzle 30 that has an axial length 36. In the shown exemplary embodiment, the engine further comprises a thrust reverser 20 that is formed upstream of the nozzle 30 and extends over an axial length 21. Such a thrust reverser 20 is optional. In addition, an afterburner can optionally be provided.

The line 4 that extends perpendicular to the machine axis 10 in FIG. 1 is an imaginary line, indicating the axial position at which the thrust reverser 20 ends and the nozzle 30 begins.

Structurally, the nozzle 30 is formed by an inner wall 31 and an outer wall 32. Here, the inner wall 31 forms the radially outer boundary of the flow channel 15 in the nozzle 30. The outer wall 32 is formed radially outside with respect to the inner wall 31 and borders the environment. It can comprise multiple walls. Downstream, the inner wall 31 and the outer wall 32 taper off towards each other, forming a nozzle exit edge 33 at their downstream end.

The inner wall 31 is comprised of a first group of adjustable segments 40 that from an upstream convergent area of the nozzle 30, and of a second group of adjustable segments 50 that from a downstream cylindrical/divergent area of the nozzle 30. The adjustable segments 40, 50 of each group are arranged in a rotationally symmetrical manner in the circumferential direction about the machine axis 10. The outer wall 32 can also be comprised of a group of adjustable segments. The shown exemplary embodiment relates to a three-dimensional nozzle with a circular cross section of the inner wall 31.

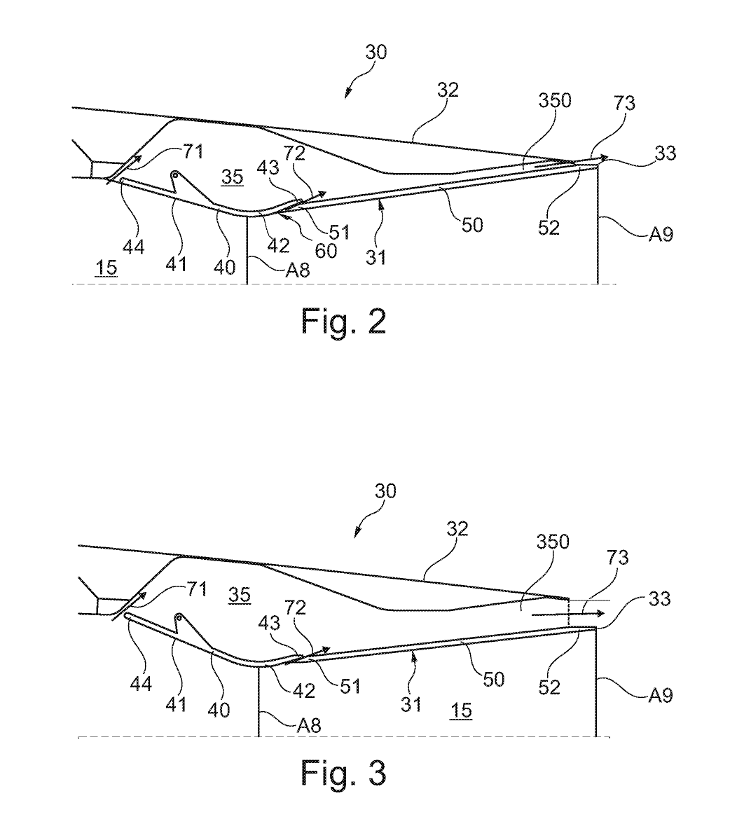

The embodiment of the nozzle 30 is further described by referring to FIGS. 2 to 5. In the shown sectional view, an adjustable segment 40 of the first group and an adjustable segment 50 of the second group are respectively shown. It is to be understood that each group has a plurality of such segments that are arranged so as to be adjacent in the circumferential direction and to jointly form an outer boundary of the flow channel 15.

According to FIG. 2, the adjustable segment 40 of the first group has a first upstream area 41 and a second downstream area 42. The upstream area 41 ends at the upstream end 44 of the segment 40. The downstream area 42 ends at the downstream end 43 of the segment 40. The segment 40 is embodied in a linear manner in the upstream area 41. This means that it is not curved in the longitudinal direction within the linear area. In contrast to that, the segment 40 is embodied in a curved manner in the downstream area 42, and namely in such a manner that it is curved in a convex manner towards the flow channel 15, thus forming a protrusion towards the flow channel 15.

In its convexly curved downstream area 42, the segment 40 forms the nozzle throat surface A8 of the flow channel 15. Naturally, the nozzle exit surface A9 is formed at the nozzle exit edge 33. What is referred to as a nozzle throat surface here is the narrowest cross-sectional surface of the flow channel 15, and what is referred to as the nozzle exit surface is the cross-sectional surface of the flow channel 15 at the rear end of the nozzle 30.

As for its axial position, the curved area 42 begins in front of the nozzle throat surface A8 and extends up to the upstream end 43 of the segment 40. The nozzle throat surface A8 is thus formed in a smooth, continuously curved area of the inner wall 31 of the nozzle 30. As a result, the generation of shock waves during the transition of the flow from the subsonic area in front of the nozzle throat surface A8 to the supersonic area behind the nozzle throat surface A8 is prevented or reduced.

Downstream of the nozzle throat surface A8, the segment 40 adjoins the axially connecting segment 50 of the second group of adjustable segments forming the downstream cylindrical/divergent area of the nozzle 30. The segment 50 of the second group is embodied in a linear manner, i.e. it is not curved in the longitudinal direction. It can be curved in the transverse direction, but does not have to be so. The segment 50 has an upstream end 51 and a downstream end 52, forming the nozzle exit edge 33 at the downstream end 52.

The transition between the segment 40 and the segment 50 is formed in such a manner that the two segments 40, 50 overlap at their facing ends 43, 51. Further, the segment 50 abuts the convex curved area 42 of the segment 40 radially inside. Here, it is provided that the linearly formed segment 50 represents the tangential extension of the segment 40. This means that the linearly formed segment 50 is aligned corresponding to a tangent that is applied at the convex curved area 42 of the segment 40 at a position 60 in which the upstream end 51 of the linearly extending segment 50 abuts the segment 40, and starting from which the segment 50 forms the inner boundary of the flow channel 15 in the axial direction.

Here, it is provided according to one embodiment that the segment 50 is beveled at its upstream end 51, so that a smooth transition between the two segments 40, 50 is provided.

In total, what is created by means of the segments 40, 50 is an area of the flow channel 15 that is initially linearly converging, i.e. conical, in the flow direction (bordered by the linear area 41 of the segments 40), with a convexly curved area (bordered by the convexly curved area 42 of the segments 40) that forms the nozzle throat surface A8 connecting thereto and extending further downstream of the nozzle throat surface A8, wherein a cylindrical/divergent area 50 (bordered by the linear segments 50) connects to the convex curved area. The cylindrical/divergent area is formed either in a cylindrical manner (with a constant cross-sectional surface) or a divergent manner (with a cross-sectional surface that increases in the flow direction) independently of the operating state or the orientation of the segments 50. In total, what is thus present is a convergent/cylindrical or a convergent/divergent nozzle.

The nozzle 30 also provides another function in addition to the described smooth and thus low-noise embodiment of the nozzle throat surface A8 thanks to the curved area 42 of the segments 40. Namely, a hollow space 35 extends between the inner wall 31 and the outer wall 32 of the nozzle 30. Downstream, the hollow space ends in a trailing edge gap 350. As indicated by arrow 71, gas flows from the flow channel 15 into the hollow space 35 via passages inside the inner wall 31 upstream of the upstream-side end 44 of the segments 40. In addition or alternatively, the gas from the flow channel 15 flows through a gap between the overlapping ends 43, 51 of the segments 40, 50 into the hollow space 35. The inflowing air is discharged from the hollow space 35 via the trailing edge gap 350, in a manner corresponding to arrow 73. The air that is discharged from the trailing edge gap 350 supplies additional energy to the air flow at the circumference of the nozzle exit edge 33 and thus reduces the base drag behind the nozzle 30.

FIG. 2 shows the nozzle 30 in a supersonic operating mode during cruising flight. The nozzle exit surface A9 is maximal and the cross-sectional surface provided by the trailing edge gap 350 is minimal.

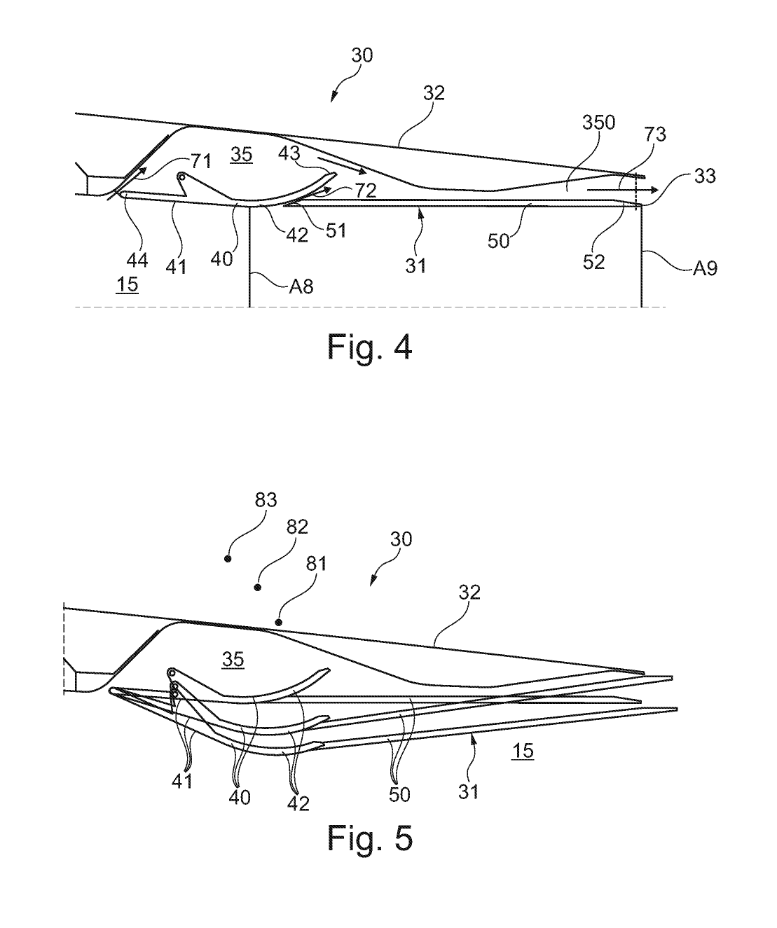

In contrast to that, FIG. 3 shows the nozzle 30 in a subsonic operating mode during cruising flight. As compared to FIG. 2, the nozzle exit surface A9 is reduced and the cross-sectional surface provided by the trailing edge gap 350 is enlarged. FIG. 4 shows the engine during take off thrust (MTO—maximum takeoff thrust). The nozzle exit surface A9 is minimal, wherein in this case the downstream area of the nozzle 30 is embodied in a cylindrical manner. The cross-sectional surface provided by the trailing edge gap 350 is maximal.

FIG. 5 shows the three operating modes and the three accompanying orientations of the segments 40, 50, wherein respectively different combinations of the nozzle throat surface A8 and the nozzle exit surface A8 are realized. As can be clearly seen, the degree of overlap of the segments 40, 50 is subject to variation, with the downstream end 43 of the convexly curved area 42 of the segments 40 of the first group of adjustable segments projecting into the hollow space 35 to different degrees.

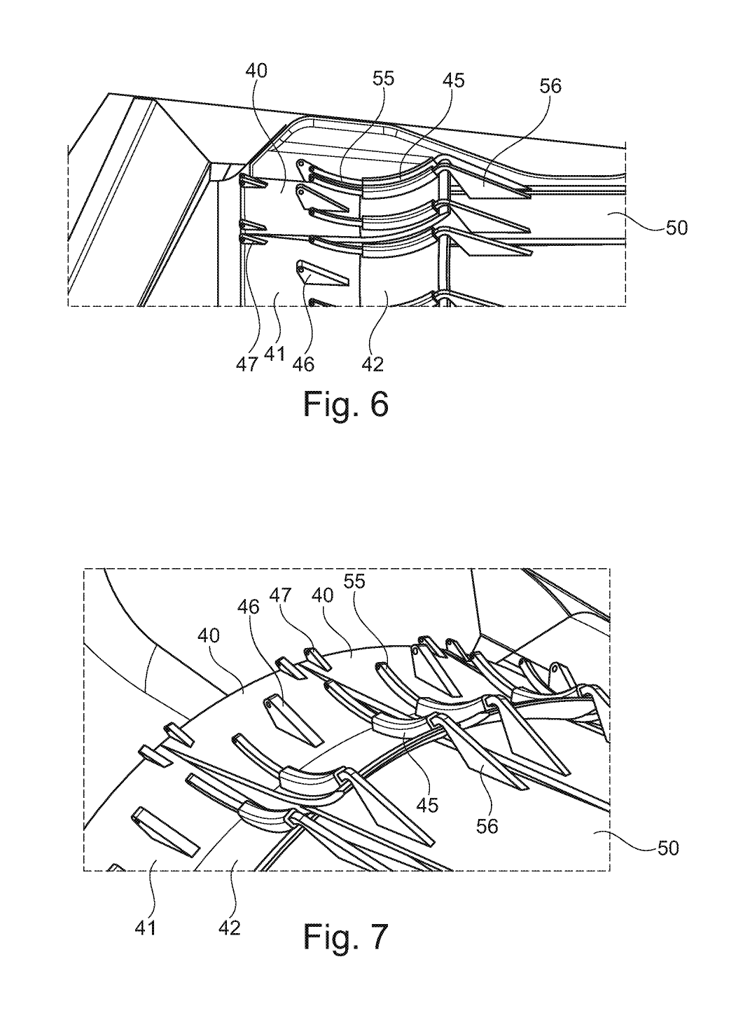

In FIG. 5, there are also three drawn-in pivot axes 81, 82, 83, indicating the pivot axis of the convexly curved area 82 of the segments 40 in the three configurations of FIGS. 2, 3 and 4. As can be seen, the pivot axes 81, 82, 83 are respectively located outside the nozzle 30. Thus, in order to realize an adjustment of the segments 40, 50, a slide mechanism is provided, which does not require for structural elements to be arranged on the pivot axis, as will be explained in the following by referring to FIGS. 6 to 9.

First referring to FIGS. 6 and 7, what is shown therein is the side of the segments 40, 50 that is facing away from the flow channel, i.e. the side that is facing towards the hollow space 35 in the rendering of FIGS. 2 to 5. At this side, which is facing away from the flow, a curved longitudinal guide is realized as a slide mechanism. It comprises a curved rail 55 that is curved corresponding to the curvature of the convexly curved area 42 of the segments 40 and is guided inside an elongated and likewise curved receiving profile 45 formed at the convexly curved area 42 of the segment 40. Here, the curved rail 55 is attached via an attachment element 56 at the linearly shaped segment 50 that is arranged downstream. Via the curved rail 55 and the curved receiving profile 45, the segments 40, 50 can be displaced with respect to each other in a defined manner in the longitudinal direction.

The inner side of the segments 40 further comprises first and second attachment elements 46, 47 at the linearly shaped upstream area 41. Via cylindrical bores or the like formed at the first attachment elements 46, the segments 40 are connected in an articulated manner with first actuators, which are not shown and which may for example be driven in a hydraulic or pneumatic manner and are affixed at a fixated part of the nozzle. Such actuators are per se known, and for example comprise a linearly movable piston. Correspondingly, the curved rails 55 are connected in an articulated manner to second actuators, which are not shown, via cylindrical bores or the like formed at the curved rails 55, wherein the second actuators may for example be operated in a hydraulic or pneumatic manner. The second attachment elements 57 of the segments 40 serve to provide an articulated connection of the segments to an upstream fixed structure, which is not shown.

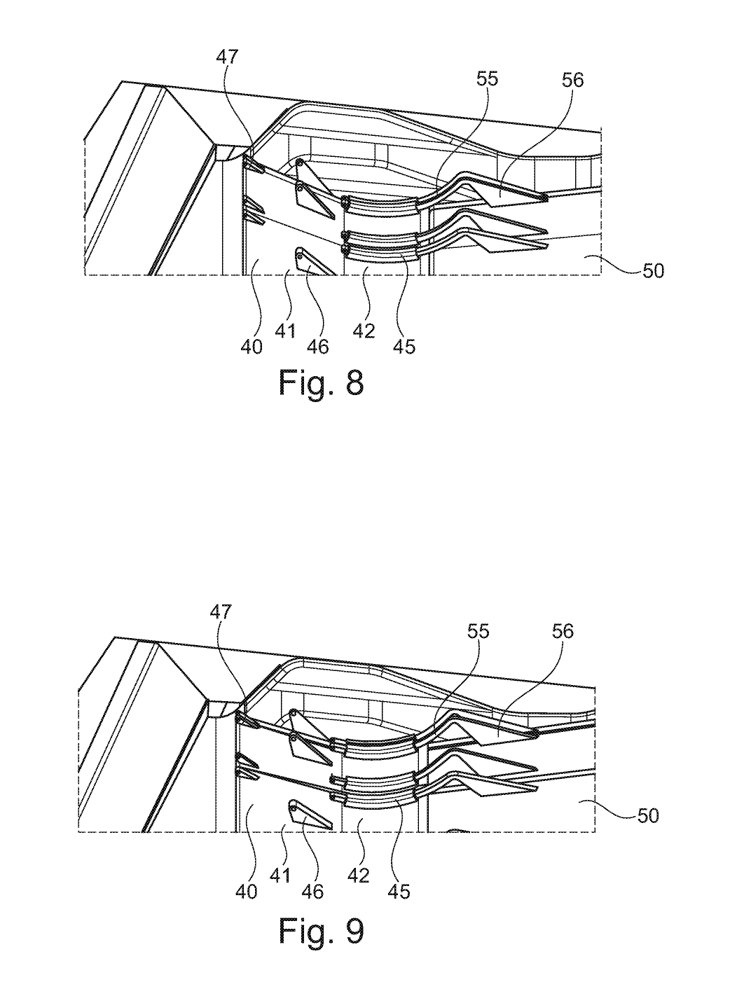

FIGS. 8 and 9 show the segments 40, 50 of FIGS. 6 and 7 in a different position in which the degree of overlap between the segments 40, 50 is minimal (FIG. 8) or reduced as compared to FIGS. 6 and 7 (FIG. 9). The basic structure is the same as in FIGS. 6 and 7, so that the respective description is referred to.

FIGS. 1 to 9 relate to an exemplary embodiment in which the nozzle is formed as a three-dimensional nozzle with a circular cross section. Alternatively, it can be provided that the nozzle is formed as a two-dimensional nozzle with a substantially rectangular cross section (with roundings at the edges). A two-dimensional nozzle is associated with the advantage of a simplified embodiment of the movable elements of the nozzle.

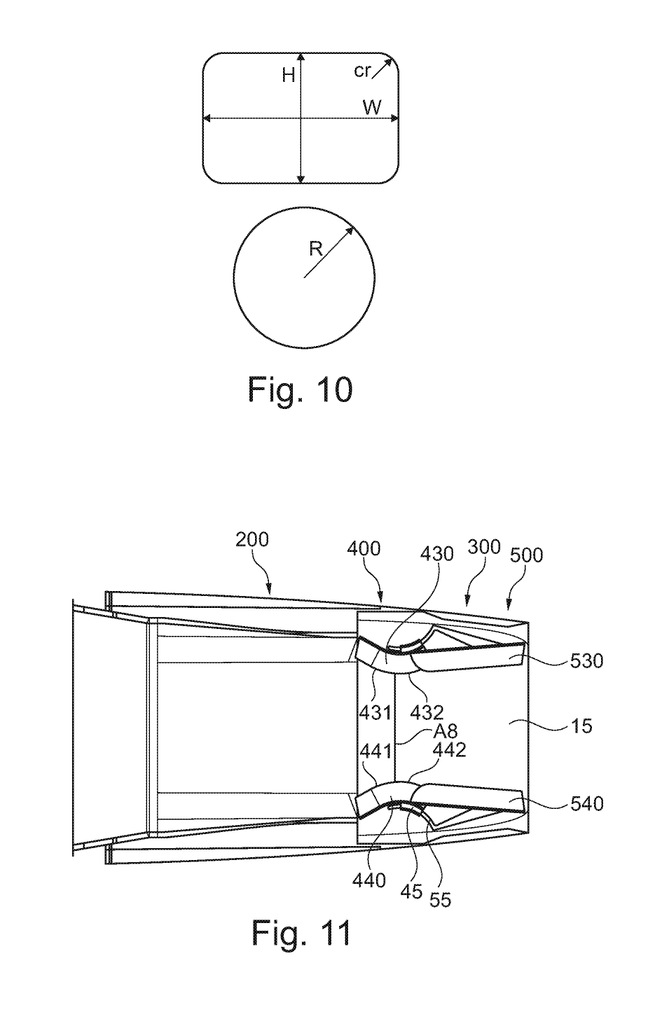

FIG. 10 shows, in a schematic manner, a rectangular cross section of a nozzle and a circular cross section of a nozzle. Here, the shown cross section is respectively the cross section of the inner wall that delimits the flow channel through the nozzle radially outside. The rectangular cross section has a height H and a width W. The corners are rounded and have a radius of curvature cr. The circular cross section is defined by its radius R.

FIGS. 11 to 16 show an exemplary embodiment of a two-dimensional nozzle 300 that has a convex curved area forming the nozzle throat surface corresponding to the present invention. Here, FIGS. 11 to 13 show the nozzle 300 in a first position, and FIGS. 14 to 16 show the nozzle 300 in a second position.

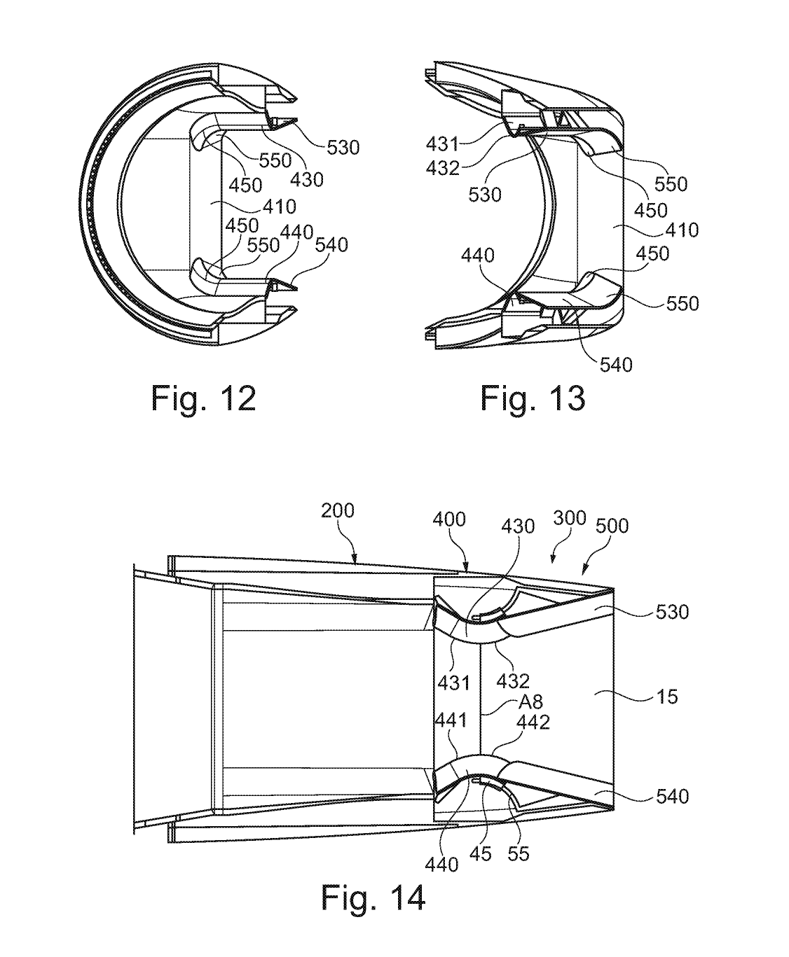

FIGS. 11 and 14 show the rear part of a turbofan engine that comprises a thrust reverser 200 and a nozzle 300. In an upstream convergent area 400, the nozzle 300 comprises two stationary side walls, an adjustable upper wall 430, and an adjustable lower wall 440. A downstream divergent area 500 connecting thereto in the axial direction also comprises two stationary side walls, an adjustable upper wall 530, as well as an adjustable lower wall 540. Here, the stationary side walls of the front area 400 and of the rear area 500 can be formed by the same wall. Additionally provided in the upstream area 400 as well as in the downstream area 500 are adjustable corner segments 450, 550 having a radius of curvature in the circumferential direction and extending into the corner area between the side walls and the upper and lower walls 430, 440, 530, 540, as can be seen in FIGS. 12, 13 and 15, 16.

Here, the adjustable walls 430, 440 and the adjustable corner segments 450 represent a first group of adjustable segments of the upstream area 400 of the nozzle 300. The adjustable walls 530, 540 and the adjustable corner segments 550 represent a second group of adjustable segments of the downstream area 500 of the nozzle 300.

As can in particular be seen in FIGS. 11 and 14, the upper and lower wall 430, 440 comprise respectively one upstream area 431, 441 that is formed in a linear and at the same time smooth manner, and a downstream area 432, 442 that is curved in a convex manner towards the flow channel 15. In the area of the convex curvature, the nozzle 300 forms the nozzle throat surface A8 corresponding to the three-dimensional embodiment of FIGS. 1 to 9.

Downstream of the nozzle throat surface A8, the convex curved area 432, 442 abuts the upper movable wall 530 or the lower movable wall 540 of the rear area 500 of the nozzle 300.

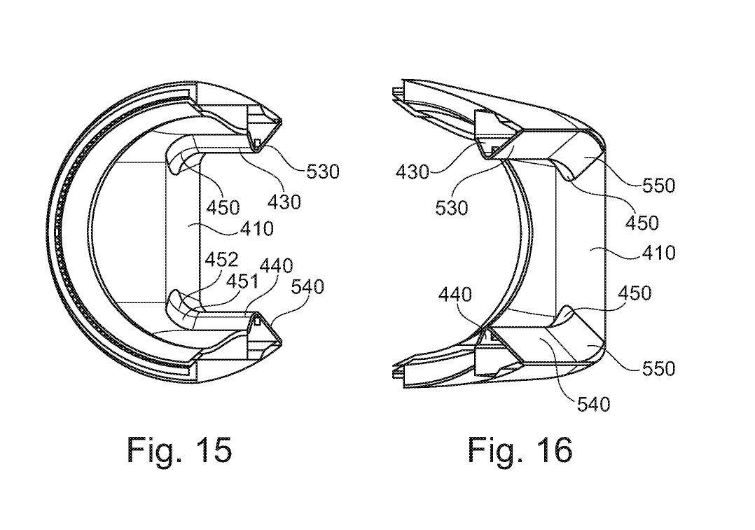

Further, it also applies to the corner segments 450, 550 that the corner segments 450 of the upstream converging area 400 have a linear area 451 as well as an area 452 that is curved in a convex manner towards the flow channel (cf. FIG. 15), wherein the nozzle throat surface is formed in the area of the convex curvature. Downstream of the nozzle throat surface, the corner segment 450 abuts a corner segment 550 of the rear convergent area 500.

The nozzle throat surface A8 is thus formed by the cross-sectional surface in the nozzle 300, in which it is minimal due to the convex curvature of the upper wall 430, the lower wall 440 and the corner areas 450. By providing a convexly curved delimitation of the flow channel 15 in the area of the nozzle throat surface A8, the generation of shock waves and as a result a strong noise development is prevented or at least reduced in an efficient manner.

The mechanical connection between the walls 430, 440 or the corner areas 450 of the front area 400 and the walls 530, 540 or the corner areas 550 of the front area 500 can be realized in a manner corresponding to the one described with respect to FIGS. 6 to 9. Correspondingly curved longitudinal guides 45, 55 are shown in FIGS. 11 and 14.

Further, is to be understood that a reduction of the base drag by conducting gas of the flow channel into a hollow space between the inner wall and the outer wall of the nozzle and by blowing off this gas at a trailing edge gap of the nozzle can also be carried out in the exemplary embodiment of FIGS. 11 to 16. With that in mind, the respective explanations pertaining to FIGS. 1 to 9 are referred to. Here, a reduction of the base drag is achieved to a particular extent by gas being additionally conducted into low-pressure areas in the corner areas.

The present invention is not limited in its embodiment to the above-described exemplary embodiments, which are to be understood merely as examples. For instance, the specific embodiment of the front segments and the rear segments, in particular their length and curvature, are to be understood merely as examples. It is also to be understood that the segments of the first group forming the upstream convergent area of the nozzle are respectively curved in a convex manner in the shown exemplary embodiments. Alternatively, the segments of the second group forming the downstream constant/divergent area of the nozzle can form a convex curvature in a corresponding manner.

It is furthermore pointed out that the features of the individually described exemplary embodiments of the invention can be combined in various combinations with one another. Where areas are defined, they include all the values within these areas and all the sub-areas falling within an area.

What is claimed is:

1. A convergent-divergent nozzle for a turbofan engine of a supersonic aircraft, having an inner wall that delimits a flow channel through the nozzle radially outside, wherein the flow channel has a nozzle throat surface and a nozzle exit surface, and the inner wall comprises:
a first group of adjustable segments forming an upstream convergent area of the nozzle, and
a second group of adjustable segments forming a downstream constant/divergent area of the nozzle,
wherein the segments of the first group or the segments of the second group are curved in a convex manner towards the flow channel at least in an area that adjoins the other group, forming the nozzle throat surface in the area of the convex curvature and abutting the segments of the respectively other group at an axial distance to the axial position of the nozzle throat surface,
wherein adjoining segments of both groups are connected to each other via a slide mechanism, wherein the adjoining segments of both groups overlap, and wherein the slide mechanism alters the degree of overlap of the adjoining segments as the nozzle throat surface is being adjusted.

2. The nozzle according to claim 1, wherein the segments of the first group forming the upstream area of the nozzle are curved in a convex manner towards the flow channel and from the nozzle throat surface in the area of the convex curvature, wherein the segments of the first group abut the segments of the second group downstream of the nozzle throat surface.

3. The nozzle according to claim 1, wherein the segments of the second group forming the downstream area of the nozzle are curved in a convex manner towards the flow channel and form the nozzle throat surface in the area of the convex curvature, wherein the segments of the second group abut the segments of the first group upstream of the nozzle throat surface.

4. The nozzle according to claim 1, wherein the segments of both groups abut each other in such a manner that respectively two segments overlap each other, wherein respectively one linearly shaped segment of the one group overlaps a convexly curved segment of the other group.

5. The nozzle according to claim 4, wherein two segments of both groups respectively abut each other and are aligned with respect to one another in such a manner that the linearly shaped segment forms the tangential extension of the convexly curved segment.

6. The nozzle according to claim 4, wherein the linearly shaped segment abuts the convexly curved segment of the other group radially inside.

7. The nozzle according to claim 1, wherein the convexly curved segments of the one group are curved in a convex manner only in the area that abuts the segments of the other group, and otherwise extend in the longitudinal direction in a substantially linear manner.

8. The nozzle according to claim 1, wherein the slide mechanism has a curved longitudinal guide that is formed on the side of the segment that is facing away from the flow channel.

9. The nozzle according to claim 8, wherein the curved longitudinal guide is embodied in such a manner for two adjoining segments of both groups that it has a curved rail which is curved in a manner corresponding to the convex curvature of the convexly curved segment and connected to the non-convexly curved segment, and has an elongated receiving profile curved in a manner corresponding to the convex curvature of the convexly curved segment and formed at the convexly curved segment, wherein the curved rail can be displaced inside the curved receiving profile in the longitudinal direction.

10. The nozzle according to claim 1, wherein the nozzle is embodied as a three-dimensional nozzle, wherein the segments of both groups are respectively distributed in the circumferential direction about the machine axis of the nozzle.

11. The nozzle according to claim 1, wherein the nozzle is embodied as a two-dimensional nozzle.

12. The nozzle according to claim 11, wherein the nozzle has two facing stationary walls and two facing adjustable walls in the upstream convergent area, that it also has two facing stationary walls and two facing adjustable walls in the downstream constant/divergent area, and in that the adjustable walls of the convergent area or the adjustable walls of the divergent area are curved in a convex manner towards the flow channel, forming the nozzle throat surface in the area of the convex curvature and abutting the adjustable walls of the respectively other area at an axial distance to the axial position of the nozzle throat surface.

13. The nozzle according to claim 12, wherein, as further adjustable segments, the nozzle has corner segments, which are rounded in the circumferential direction, in the corner area between the stationary walls and the adjustable walls in the upstream convergent area as well as in the downstream divergent area, wherein it also applies to the rounded corner segments that the rounded corner segments of the convergent area or the rounded corner segments of the divergent area are curved in a convex manner towards the flow channel, contribute to the formation of the nozzle throat surface in the area of the convex curvature and abut a rounded corner segment of the respectively other area at an axial distance to the axial position of the nozzle throat surface.

14. The nozzle according to claim 1, wherein the segments of the first group and the segments of the second group abut each other in such a manner that gas flows between them from the flow channel into a hollow space between the inner wall and an outer wall of the nozzle, wherein this hollow space is embodied in such a manner that the inflowing gas is discharged from the nozzle in the area of a trailing edge gap between the inner wall and the outer wall.

15. The nozzle according to claim 1, wherein passages are formed inside the inner wall of the nozzle at the upstream end of the upstream convergent area of the nozzle, namely in such a manner that gas flows into a hollow space between the inner wall and an outer wall of the nozzle, wherein this hollow space is embodied in such a manner that the inflowing gas is discharged from the nozzle in the area of a trailing edge gap between the inner wall and the outer wall.

16. A convergent-divergent nozzle for a turbofan engine of a supersonic aircraft, wherein the nozzle comprises:
an inner wall that delimits a flow channel through the nozzle radially outside, wherein the flow channel has a nozzle throat surface and a nozzle exit surface,
wherein the inner wall comprises: a first group of adjustable segments forming an upstream convergent area of the nozzle, and a second group of adjustable segments forming a downstream constant/divergent area of the nozzle,
wherein the segments of the first group or the segments of the second group are curved in a convex manner towards the flow channel at least in an area that adjoins the other group, forming the nozzle throat surface in the area of the convex curvature and abutting the segments of the respectively other group at an axial distance to the axial position of the nozzle throat surface,
the segments of both groups abut each other in such a manner that respectively two segments overlap each other, wherein respectively one linearly shaped segment of the one group overlaps a convexly curved segment of the other group, and wherein
the convex curved segments of the one group are curved in a convex manner only in an area that abuts the segments of the other group, and otherwise extend in the longitudinal direction in a substantially linear manner.

17. A method for reducing the base drag behind a convergent-divergent nozzle, in which the inner wall of the nozzle has a first group of adjustable segments forming an upstream convergent area of the nozzle, and a second group of adjustable segments forming a downstream constant/divergent area of the nozzle, wherein the method comprises:
conducting gas of the flow channel in front of the upstream end of the upstream area of the nozzle and/or between the upstream and the downstream area of the nozzle into a hollow space between the inner wall and an outer wall of the nozzle;
conducting the inflowing gas in the hollow space between the inner wall and the outer wall in such a manner that it is discharged from the nozzle in the area of a trailing edge gap between the inner wall and the outer wall.

18. The method according to claim 17, wherein gas of the flow channel flows into the hollow space (34) between segments of the first group and segments of the second group.

19. The method according to claim 17, wherein gas of the flow channel flows into the hollow space between the upstream end of the segments of the upstream area and a solid structure at which these are affixed.
